(19) United States
(12) Patent Application Publication
(10) Pub. No.: US 2015/0040832 A1
(43) Pub. Date: Feb. 12, 2015

(54) AUTOMATIC ANIMAL FEEDING STATION

(71) Applicant: Ronald P. Klein, Driftwood, TX (US)

(72) Inventor: Ronald P. Klein, Driftwood, TX (US)

(21) Appl. No.: 13/960,230

(22) Filed: Aug. 6, 2013

(51) Int. Cl. A01K 5/02

(52) U.S. Cl. CPC A01K 5/0291
USPC 119/51.11

(57) ABSTRACT

An automated animal feeding station includes a housing having a closable lid that is hingeably attached to the housing. The housing includes a removable liner that forms an interior surface having one or more feeding compartments. The lid is hingeably attached to the housing such that when closed, the lid forms a sealable cover over the opening. The animal feeding station may include a sealing surface that forms a seal to the lid such that when the lid is closed, air and moisture transfer between the interior and the exterior of the housing is reduced. The animal feeding station also includes motor unit that is mechanically coupled between the housing and the lid, and may be open and close the lid upon actuation by motor control signals provided by a programmable control unit based upon a user defined feeding schedule and an identification sensor.

### BACKGROUND

1. Technical Field

This disclosure relates to animal feeding systems, and more particularly to an automated animal feeding station.

2. Description of the Related Art

People that own small animals have always had a need for a way to feed their animals when they are away. In the past, animal owners have had to rely on people to feed their animals, or place their animals in the care of a bet boarding facility. Both of those options can be prohibitively expensive for many people. In recent years, a large number of automatic style pet feeders have emerged into the marketplace. In particular, feeding units have been developed that use some type of timer to automatically dispense feed to an animal. While many of these types of feeders have features that allow animals to be fed in the absence of the owner, the currently available conventional feeders continue to have unresolved drawbacks.

Specifically, many conventional feeders typically dispense food into a container that is external to the food storage area. In such a scenario, any uneaten food is subject to ant and other insect infestation, or the uneaten food may attract unwanted animals such as skunks, raccoons, and even other pets. Furthermore, any uneaten food may begin to spoil and cause unwanted odors, or be subject to spillage if accidentally bumped.

### SUMMARY OF THE EMBODIMENTS

Various embodiments of an automated animal feeding station are disclosed. Broadly speaking, in one embodiment, an automated animal feeding station includes a housing having a closable lid that is hingeably attached to the housing. The housing includes a removable liner that forms an interior surface having one or more feeding compartments. The lid is hingeably attached to the housing such that when closed, the lid forms a sealable cover over the opening. The animal feeding station may include a sealing surface that forms a seal to the lid such that when the lid is closed, air and moisture transfer between the interior and the exterior of the housing is reduced. The animal feeding station also includes motor unit that is mechanically coupled between the housing and the lid, and may be open and close the lid upon actuation by motor control signals provided by a programmable control unit. The control unit may operate the lid based upon a user-defined feeding schedule and an identification sensor.

### BRIEF DESCRIPTION OF THE DRAWINGS

FIG. 1A is a perspective view drawing of one embodiment of an automated animal feeding station.

FIG. 1B is a perspective view drawing of the embodiment of the automated animal feeding station of FIG. 1A with the lid open.

FIG. 1C is a side view drawing of the embodiment of the automated animal feeding station of FIG. 1A and FIG. 1B with the lid open.

FIG. 2A is a perspective view drawing of another embodiment of an automated animal feeding station with the lid open.

FIG. 2B is a rear view drawing of the embodiment of the automated animal feeding station of FIG. 2A with the lid open.

FIG. 2C is a side view drawing of the embodiment of the automated animal feeding station of FIG. 2A with the lid open.

FIG. 3 is a perspective view drawing of another embodiment of the automated animal feeding stations of FIG. 1A through FIG. 2C.

FIG. 4 is a side view drawing of another embodiment of an automated animal feeding station including a feed hopper.

FIG. 5 is a block diagram of one embodiment of a control system for operating the animal feeding stations shown in FIG. 1A through FIG. 4.

Specific embodiments are shown by way of example in the drawings and will herein be described in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits.

Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation for that unit/circuit/component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

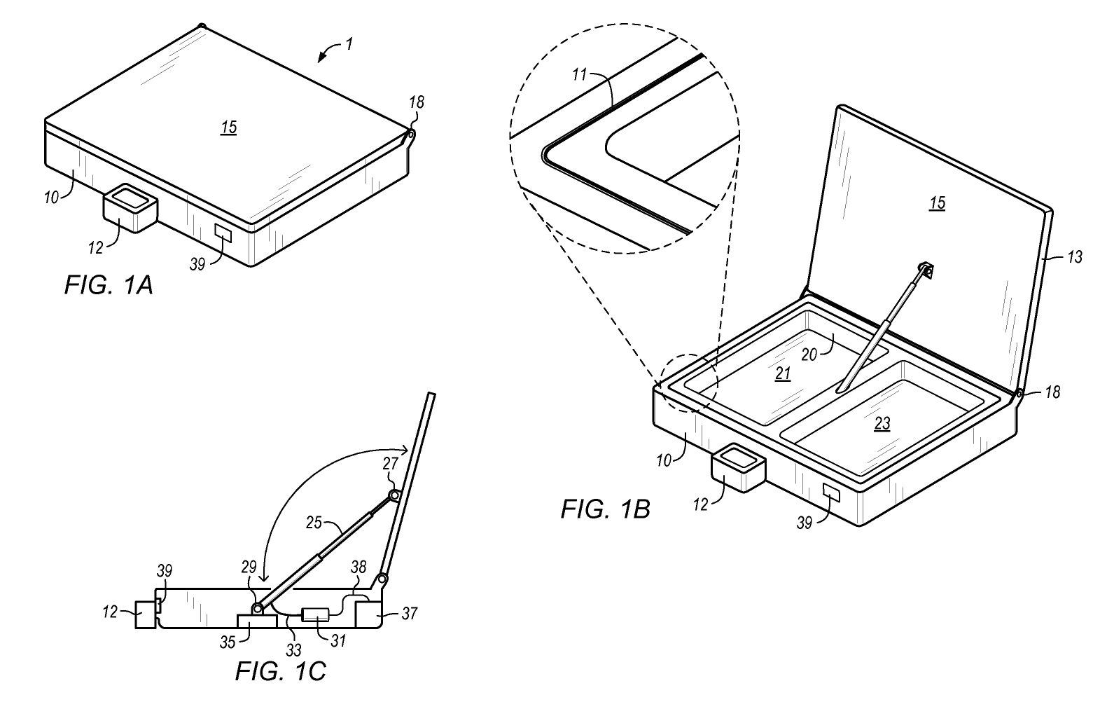

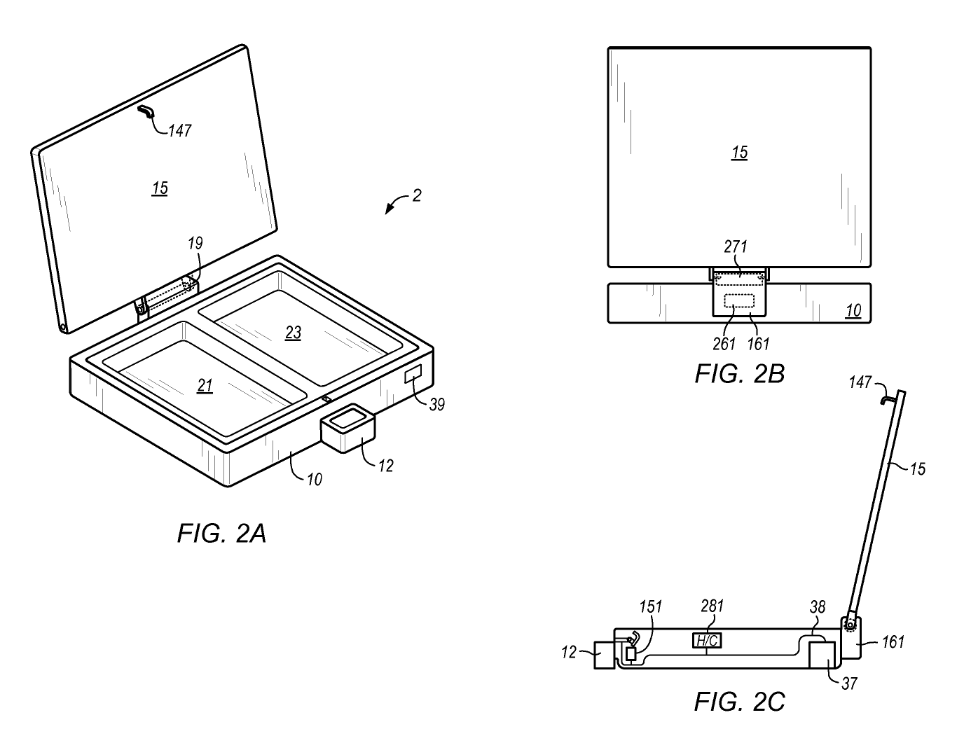

Turning now to FIG. 1A, a perspective view drawing of one embodiment of an automated animal feeding station is shown. The animal feeding station 1 of FIG. 1A includes a housing 10 with a lid 15 that is attached to the housing via a hinge assembly 18. As described further below, the hinge 18 allows the lid 15 to open and close using a variety of mechanisms that are described in more detail below in conjunction with the descriptions of FIG. 1B through FIG. 2C. The animal feeding station 1 also includes a proximity sensor unit 39 and a control housing 12. It is noted that although the housing 10 is shown as being rectangular/cuboid in shape, it is contemplated that in other embodiments the housing 10 may be formed into other shapes such as a cylinder for example.

In various embodiments, the housing 10 may be constructed of a sturdy material such as stainless steel, or any of a variety of impact resistant plastics. Similarly, the lid 15 may also be made from these types of materials. Additionally, in one embodiment, the lid 15 may be made from a translucent or semi-translucent material such as polycarbonate or other type of resin based material that affords a person the ability to observe the contents of the feed station without opening the lid 15.

As mentioned above, the lid 15 is attached to the housing 10 using hinge 18 and any of a variety of well-known hinge techniques. The hinge 18 allows the lid 15 to pivot on an axis and to open and close securely.

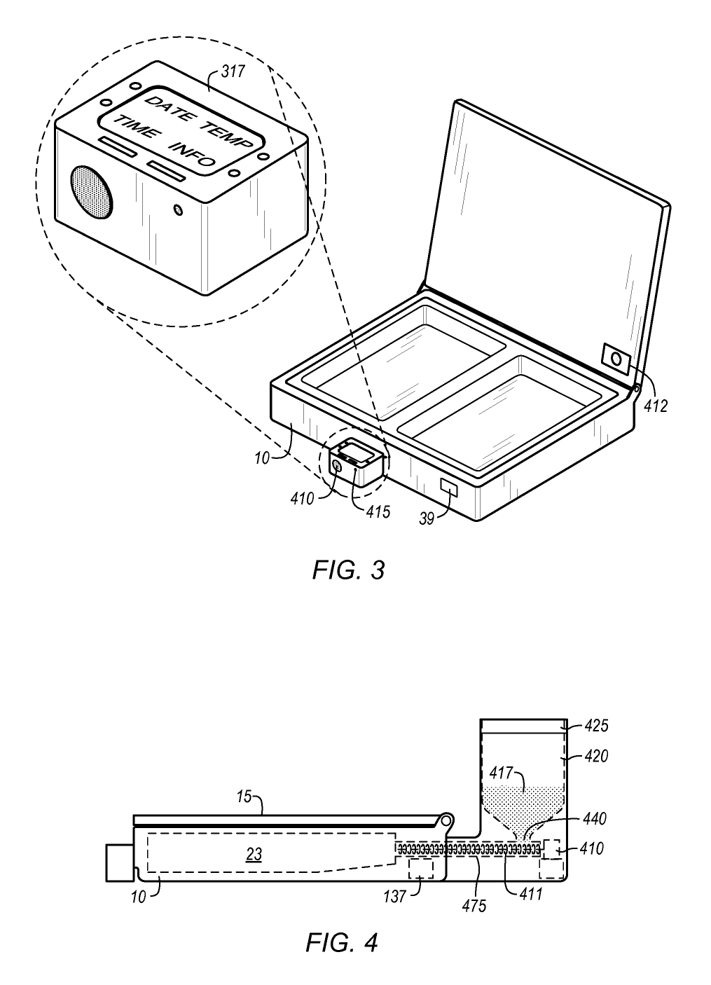

In one embodiment, the control housing 12 may include a display and one or more buttons (shown in FIG. 3). The buttons and display may allow a user to program the feeding station and to observe different types of status information that is described further below.

Referring to FIG. 1B, a perspective view drawing of an embodiment of the automated animal feeding station 1 of FIG. 1A is shown with the lid open. It is noted that components corresponding to those shown in FIG. 1A are numbered identically for clarity and simplicity. As shown in FIG. 1B, the lid 15 is in an open position. Accordingly, the interior space of the housing exposes two compartments 21 and 23, as well as a push rod assembly 25 that is attached to the lid via hinge pin assembly 27. As described in greater detail below, the push rod assembly 25 may facilitate automated opening and/or closing of the lid 15.

In one embodiment, the compartments 21 and 23 are formed by an insert 20 using material similar to that used to form the housing 10. For example, stainless steel, or any of a variety of plastics may be used to form the insert 20. As shown, the compartments 21 and 23 form hollowed out areas that store the animal feed and/or water. In addition to creating the two compartments, the insert 20 also creates hollow cavities on the underside that may be used to house the control electronics, power supply, sensors, motors, and other hardware (all not shown in FIG. 1B). It is noted that in other embodiments, the insert 20 may be formed to create other numbers of feed compartments as desired.

As shown in FIG. 1B, the area of the housing 10 that meets the lid 15 when the lid is closed forms a sealing type closure. More particularly, as shown in the exploded view of the housing 10, the housing 10 has a groove therein which holds a gasket 11. In various embodiments, the gasket 11 may be an O-ring made of rubber, silicone, or other type of soft sealing material. In one embodiment, the gasket 11 may be removable so that it may be cleaned and re-used, or replaced. In one embodiment, when the lid 15 is closed, the edge of the lid 13 mates with the gasket 11 to form an air-tight sealing surface. As such, the resultant seal may be reduce or prevent odors and liquids from escaping from the housing 10, and it may prevent ingress by insect pests.

Referring to FIG. 1C, a side view drawing of an embodiment of the automated animal feeding station of FIG. 1A and FIG. 1B is shown with the lid open. It is noted that components corresponding to those shown in FIG. 1A and FIG. 1B are numbered identically for clarity and simplicity. As shown in FIG. 1C, the lid 15 is in an open position and additional components are shown. More particularly, the push rod assembly 25 is coupled to a hinge block assembly 29 which is coupled to a mounting block 35. In addition, the interior space includes a control unit 37 that is electrically coupled to a motor unit 31 via connection 38. The motor unit 31 is coupled to the pushrod assembly 25 via a hose assembly 33.

In one embodiment, the motor unit 31 is a pneumatic drive motor that creates pneumatic pressure in the hose assembly 33 to force the pushrod assembly 25 to extend or retract. In such an embodiment, the pushrod assembly 25 may be a telescoping assembly that has a number of collapsible extension sections such when the lid 15 is closed the pushrod assembly 25 is collapsed sufficiently to be stored within a cavity between the feed compartments 21 and 23. When the lid is fully opened the pushrod assembly 25 is sufficiently extended to open the lid 15. In one embodiment, the lid 15 may be opened and closed under pressure. In such an embodiment, to prevent unintended injury to an animal, the proximity/identification (ID) sensor 39 may be used as a safety interlock that will not allow the lid to be closed if the animal's presence is detected using a variety of detection methods such as infrared or radio frequency detection, for example and as described in more detail below. In addition, the lid 15 may be pulled down sufficiently by the pushrod assembly 25 to form a seal with the gasket 11 on the housing. However, in another embodiment the lid 15 may be allowed to close under the force of gravity, after an initial pull from the pushrod assembly 25. In such an embodiment, a lid latch as described below in conjunction with the description of FIG. 2B may be used to secure the lid 15 and form a seal in the closed position.

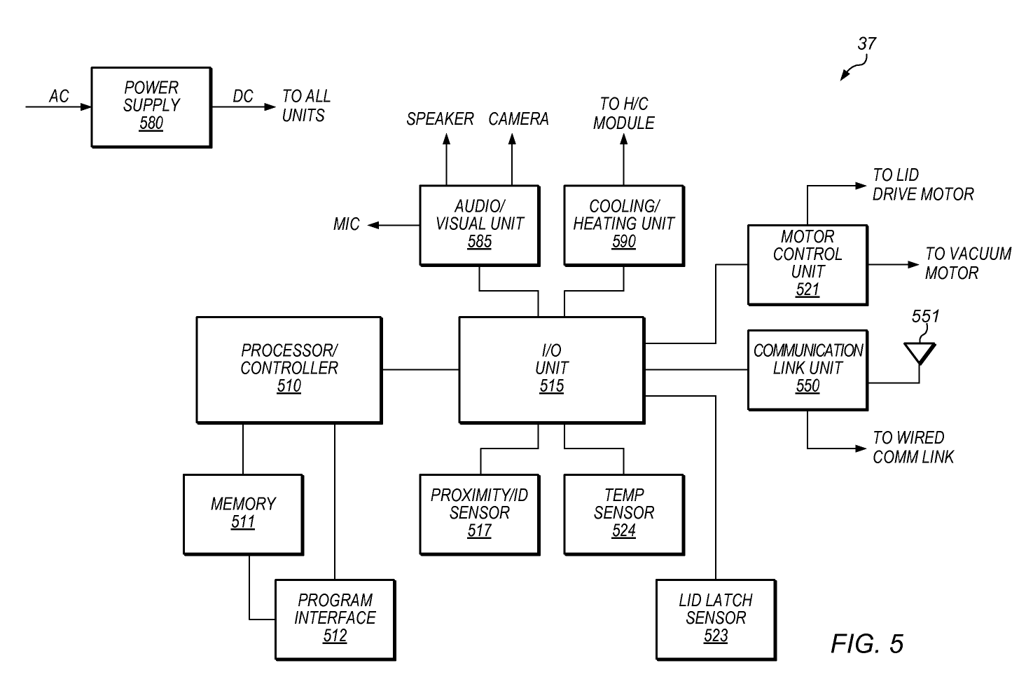

As described in greater detail below in conjunction with the description of FIG. 5, the control unit 37 may include electronics to programmably control the operation of the animal feeding station 1. More particularly, the control unit 37 may include a variety of processing circuits, power supply, sensor circuits, motor control circuits, wired and wireless communication circuits, and an interface to the control housing input unit 12.

Turning to FIG. 2A, a perspective view drawing of another embodiment of an automated animal feeding station is shown with the lid open. It is noted that components corresponding to those shown in FIG. 1A and FIG. 1C are numbered identically for clarity and simplicity. As shown in FIG. 2A, the lid 15 is in an open position. The housing 10 and the interior space are similar to that shown in the previous figures except there is no pushrod assembly 25. Indeed, the animal feeding station 2 of FIG. 2A uses a different lid hinge assembly 19 which will be described in greater detail below in conjunction with the descriptions of FIG. 2B.

Referring to FIG. 2B, a rear view drawing of the embodiment of the automated animal feeding unit of FIG. 2A is shown with the lid open. It is noted that components corresponding to those shown in FIG. 2A are numbered identically for clarity and simplicity. The animal feeding station 2 of FIG. 2B includes a motor unit 161 which includes a lid drive motor 271 and vacuum pump 261.

In one embodiment, the lid drive motor 271 is mechanically coupled to the lid 15 through the motor shaft. The shaft of the lid drive motor 271 may be fixed to the lid hinge assembly 19 in a variety of ways. For example, in one embodiment, a pin inserted through a hole in the shaft and the hinge 19 may secure the shaft to the hinge 19, while in another embodiment, the shaft may be splined and fitted into the hinge 19. Once the motor begins to turn the shaft rotates, which in turn opens and/or closes the lid 15 about an axis created by the hinge assembly 19. In one embodiment, the lid drive motor 271 may be a DC stepper motor. It is noted that in embodiments that use a heavy lid, a gear box (not shown) may be used to improve the mechanical advantage of the motor shaft.

Referring to FIG. 2C, a side view drawing of the embodiment of the automated animal feeding station of FIG. 2A is shown with the lid open. It is noted that components corresponding to those shown in FIG. 2A and FIG. 2B are numbered identically for clarity and simplicity. The feeding station 2 includes a lid latch assembly 151, a heating and cooling unit 281, and a lid catch 147. As shown, the control unit 37 is coupled to the heating and cooling module 281 and to the lid latch assembly 151.

In one embodiment, once the lid is closed, the lid latch assembly 151 engages the lid catch 147 to securely close the lid. In one embodiment, the lid latch assembly 151 may include an electrically actuated plunger having a linkage that engages and pulls the lid catch 147 down. In such an embodiment, the lid 15 is pulled down sufficiently to form a seal with the gasket 11 on the housing.

In one embodiment, instead of, or in addition to the lid latch assembly 151, once the lid is closed the control unit 37 may initiate a vacuum sequence to evacuate some of the air (to create lower than ambient air pressure) inside the housing 10. Accordingly, as shown in FIG. 2B motor unit 161 also includes a vacuum pump 261 which may evacuate enough air from within the housing to reduce the atmospheric pressure. Doing so may prolong the life of the food in the food compartments. In addition, a vacuum within the housing 10 may make the lid more difficult to open either inadvertently, or by an animal. The control unit 37 may include a motor control unit (shown in FIG. 5) which may operate the vacuum pump motor 261.

As described above in the embodiment of FIG. 1C, the proximity/ID sensor 39 may be used to reduce the likelihood of injuring an animal by preventing the lid from closing under power when the sensor indicates the presence of the animal.

In addition, to help preserve the food quality, the control unit 37 may also provide cooling and heating to the food compartments 21 and 23. In one embodiment, the control unit 37 may monitor the temperature of the compartments, and may maintain a programmably preset temperature. In one embodiment, the control unit 37 may provide, for example, Peltier effect cooling via the heating and cooling module 281 to keep the food cool in warm months and heat strips to heat the feed compartments 21 and 23 to keep the food and water from freezing during cold months.

To help prevent unwanted animals or other unauthorized pets from accessing the animal feed station, the feed station may use an ID technology such as radio frequency ID (RFID), for example. In such an embodiment, the proximity/ID sensor 39 may also be configured to interrogate and read an RFID device. Accordingly, a pet collar or other device having a tag with an RFID device may be placed on the animal. Alternatively, an RFID chip such as those implanted into the animal by veterinarians may be used. When the animal comes close enough (i.e., some programmable distance) to activate the RFID tag, and if the feed station has been programmed to open at that time, the control unit 37 may open the lid 15. However, if the authorized animal leaves, or is forced to leave by, for example, another animal, the proximity/ID sensor 39 detects that the animal has left and the control unit 37 may close the lid 15. As described above, to reduce the likelihood of injury to the animal the lid 15 may be prevented from closing when the proximity/ID sensor 39 detects the presence of the animal.

It is noted that while the embodiments of FIG. 1A through FIG. 1C and FIG. 2A through FIG. 2C show specific examples of hinge assemblies, it is contemplated that in other embodiments other hinge assemblies may be used.

Turning to FIG. 3, a perspective view drawing illustrating additional details of an embodiment of the automated animal feeding station of FIG. 1A through FIG. 2C is shown. In FIG. 3, the control housing 12 includes an audio speaker 410, a microphone 415, and a user interface 317. In addition, the lid of animal feeding station includes a video camera 412.

The audio speaker 410 allows a user to play a prerecorded audio segment for the animal(s) that feed at the station. In addition, in embodiments that use a wireless or wired communication link as described further below, the speaker 410 allows a pet owner or other user to call in to the feed station and the speaker 410 to broadcast the user's voice. Similarly, the microphone 415 may allow a user record the ambient sound around the feed station, or to allow “live” listening by providing the ambient sound through a communication link via the communication link mentioned above.

In one embodiment, the animal feeding station may be completely programmable. Accordingly, a user may program the unit to open and close, heat and cool, refill, and to initiate video and/or audio recording, and/or audio output based on a user selected schedule via the user interface 317. As shown in the exploded view of FIG. 3, the user interface 317 includes a display, and a number of push buttons. The display may graphically display such information as the date, time, temperature, and whether the animal feeding station is in standby or actively feeding an animal, and any other status and programming information as desired.

In various embodiments, the animal feeding station may include a communication link (shown in FIG. 5). In one embodiment, the communication link may be hardwired through a phone line or a network connection such as an Ethernet connection, for example. In other embodiments, the communication link may be a wireless link established through a Bluetooth, WiFi, WiMax, or a cellular or other radio connection for example. In other embodiments, the animal feeding station may use both wired and wireless communication links, as desired. In embodiments that have the communication link, a user may connect with and operate the animal feeding station locally or remotely, or program the unit locally or remotely via the communication link. In addition, through the communication link a user may listen in through the microphone 415, and/or talk to their animals via the speaker 410. Further, the video camera 412 may allow a user to remotely view in real rime, the area surrounding the animal feeding station. The programmability also allows a user to record video at any time, but it may be useful to record video during programmed feeding times, for example.

Referring to FIG. 4, a side view drawing of another embodiment of an automated animal feeding station including a feed hopper is shown. It is noted that components corresponding to those shown in FIG. 1A through FIG. 2C are numbered identically for clarity and simplicity. The animal feeding station is shown with a feed hopper 420. The hopper 420 includes a cover 425 and a feed motor 410 whose shaft that is coupled to a feeding mechanism 411. In one embodiment, the feed hopper 420 may be detachable from the housing 10. In various embodiments, the housing 10 may be mated to the hopper 420 via a number of screws, or retaining tabs that lock the hopper 420 into position.

In one embodiment, the hopper 420 may be filled with animal feed in the form of kibbles. The hopper 420 is shaped to have curved sides that slope toward a center aperture 440, thereby allowing the kibbles to gravity feed into contact with the feeding mechanism 411. When it is time to dispense food into the housing 10, the shaft of the motor 410 begins to rotate. In one embodiment, the feeding mechanism 411 is formed into a spiral. The rotation of the motor shaft rotates the spiral feeding mechanism 411 and causes kibbles to be transported from the aperture in the hopper to the compartment 23 of the housing 10. In the illustrated embodiment, the compartment 23 has a sloped bottom from the rear (right side in FIG. 4) of the compartment 23 to the front. The slope may aid the dispensed kibble in being deposited across the bottom of the compartment 23. In one embodiment, the feeding mechanism 411 is housed in a round tubular housing 475 which extends from the aperture 440 in the hopper 420 to another aperture in the rear wall of the compartment.

In one embodiment, the motor 410 is controlled by the control unit 37. In addition to programmably selecting a time to open and close the lid 15, the animal feeding station may be programmed to dispense food into the compartment 23 from the hopper at predetermined intervals or in response to an immediate command entered by a user in real time. In one embodiment, the motor 410 may be coupled electrically to the control unit 37 via a cable and connector assembly (not shown).

It is noted that a second dispenser (not shown) may be used to dispense water or other liquids in a similar way as the food into the other compartment (e.g., 21) using a second hopper (not shown). In such an embodiment, rather than a spiral drive feeding mechanism, a simple electronically actuated valve may be used to control dispensing of the liquids into the compartment.

Turning to FIG. 5, a block diagram of one embodiment of a control unit for operating the animal feeding stations shown in FIG. 1A through FIG. 4 is shown. The control unit 37 includes a processor/controller 510 coupled to an input/output (I/O) unit 515. The processor 510 is also coupled to a memory unit 511 and to a programmer interface 512. The I/O unit 515 is coupled to a number of sensor units and/or peripheral controllers. For example, the I/O unit 51 is coupled to a proximity/ID sensor 39, a temperature sensor 524, and a lid latch sensor 523. The I/O unit 515 is coupled to a communication link unit 550, a heating/cooling unit 590, an audio/visual unit 585, and a motor control unit 521. As shown the control unit 37 also includes a power supply 580 that is coupled to provide power to all units.

In one embodiment, the processor/controller 510 may include a processor core that may execute instructions. The instructions may be stored in the memory unit 511 and retrieved for execution by the processor/controller 510. The processor/controller 510 may provide communication and control signals to the peripheral controllers and may receive sensor signals through the I/O unit 515.

In one embodiment, the I/O unit 515 may control handling and routing of messages and communications between components connected to the processor controller 510. The I/O unit may include a number of buffers to facilitate communication link flow control.

In one embodiment, the proximity/ID sensor 39 may include an infrared sensor, and a radio frequency transmitter/receiver. The proximity sensor may be configured to detect the presence of any object, and in particular it may further be configured to identify a specific object such as, for example, an object having a corresponding RFID tag or module. In one embodiment, the proximity sensor 39 may send information to the processor/controller 510 for processing. In other embodiments, the proximity sensor may be relatively self-contained and only send conformation information such as go/no-go information. The proximity/ID sensor 39 may be programmed via the program interface 512, which may be coupled to the user interface 317.

The temperature sensor 524 may be used in conjunction with the cooling/heating module 590 to provide feedback to the cooling/heating module 590 during heating and/or cooling operations. The temperature sensor 524 may also provide a temperature indication to the user interface 315.

The lid latch sensor 523 may be configured to detect when the lid is fully closed and latched. The lid latch sensor 523 may provide a signal when the lid is latched. In one embodiment, his signal may allow the vacuum motor 261, cooling/heating module 590, and the heating/cooling module 281, for example, to be enabled. In addition, the absence of this signal when it is supposed to be present may cause the processor/controller 510 to provide a trouble indication to the user interface 317, as well as to the communication link unit 550.

The audio/visual unit 585 may be configured to control the camera 412, the microphone 415, and the speaker 410 as described above. Accordingly, the audio/visual unit 585 may include digital and analog audio circuits to facilitate recording and playback of both audio and video.

In one embodiment, the motor control unit 521 may provide control signals to the lid drive motor 271 and the vacuum motor 261 during operation.

As mentioned above, the cooling/heating unit 590 may control the heating cooling module 281 of FIG. 2C to provide heating and cooling within the feeding compartments 21 and 23. In one embodiment, the cooling/heating unit 590 may provide source and/sink current, as well as control signals to the heating and cooling module 281.

The communication unit 550 may communicate wirelessly via an antenna 551 and via a wired communication link. More particularly, communication link unit 550 may communicate wirelessly via any of a variety of wireless protocols as described above. The antenna 551 may be positioned anywhere within the housing 10, as desired. In wired communication, the communication link may implement any of a variety of communication protocols such as Ethernet, universal serial bus (USB), Firewire™, and the like.

In one embodiment, the power supply 580 may be an alternating current (AC) to direct current (DC) converter. Accordingly, the animal feeding station may be powered by AC electricity either at 110V or 220V nominal. The power supply 580 may convert the AC voltage to a DC voltage of any suitable value for use by the control unit 37. In other embodiments, the power supply may accommodate battery operation. Thus the animal feeding station may be operated when AC power is unavailable.

The memory 511 may include any type of memory. For example, the memory 511 may be in the DRAM family such as synchronous DRAM (SDRAM), double data rate (DDR, DDR2, DDR3, etc.), or any low power version thereof. However, memory 511 may also be implemented in SDRAM, static RAM (SRAM), or other types of RAM, etc. The memory 511 may be programmed using the programmer interface 512.

It is noted that various portions of each of the embodiments described above may be combined together, or omitted as desired.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An animal feeding system comprising:
a housing forming a container with an opening in a top surface;
a removable liner forming an interior surface of the housing, wherein the liner is formed to have an interior dimension that is smaller than an interior dimension of the housing, thereby creating a space between the liner and the housing, wherein the removable liner further forms one or more feeding compartments;
a lid that is hingeably attached to the housing such that when closed, the lid forms a sealable cover to the opening, and when open, the lid allows access through the opening;
wherein the lid includes a sealing surface that forms a seal between the housing and the lid such that when the lid is closed, air and moisture transfer between the interior and the exterior of the housing is inhibited;
a motor unit mechanically coupled between the housing and the lid, and configured to open and close the lid upon actuation by motor control signals; and
a control unit positioned within the space between the liner and the housing and configured to provide the motor control signals to the motor unit based upon a user-defined control schedule.

2. The animal feeding system of claim 1, wherein the housing forms a cuboid having an open top surface.

3. The animal feeding system of claim 1, wherein the housing forms a cylinder having an open end surface.

4. The animal feeding system of claim 1, wherein the motor unit is coupled to a control arm assembly including a mechanical linkage slidably coupled between the housing and the lid, and configured to open and close the lid upon actuation of the motor unit.

5. The animal feeding system of claim 1, wherein the motor unit includes a motor shaft coupled to the lid, wherein the motor unit is fixably mounted to the housing, and wherein the motor unit is configured to rotatably open and close the lid upon actuation of the motor unit.

6. The animal feeding system of claim 1, wherein the control arm assembly further includes a stepper motor that is responsive to the respective control signals.

7. The animal feeding system of claim 1, wherein the control arm assembly further includes a pneumatic piston and an associated electronic actuator that is responsive to the respective control signals.

8. The animal feeding system of claim 1, wherein the control unit includes a memory unit configured to store instructions.

9. The animal feeding system of claim 8, wherein the control unit includes a processing unit configured to execute the instructions.

10. The animal feeding system of claim 9, wherein then control unit includes a program interface configured to receive the instructions from a communication link and to store the instructions in the memory.

11. The animal feeding system of claim 10, wherein the communication link is further configured to provide access to remotely operate the animal feeding station.

12. The animal feeding system of claim 1, further comprising a user interface coupled to the control unit and configured to provide status information to a user.

13. An animal feeding system comprising:
a housing forming a container with an opening;
a removable liner forming an interior surface of the housing, wherein the forms one or more feeding compartments;
a lid that is hingeably attached to the housing such that when closed, the lid forms a sealable cover to the opening, and when open, the lid allows access through the opening, wherein the housing includes a sealing surface that forms a seal between to the lid such that when the lid is closed, air and moisture transfer between the interior and the exterior of the housing is reduced;
a motor unit mechanically coupled between the housing and the lid, and configured to open and close the lid upon actuation by motor control signals; and
a control unit configured to provide the motor control signals to the motor unit based upon a programmable control schedule.

14. The animal feeding system of claim 13, wherein the housing forms a cuboid having an open top surface.

15. The animal feeding system of claim 13, wherein the housing forms a cylinder having an open end surface.

16. The animal feeding system of claim 13, wherein the motor unit is coupled to a control arm assembly including a mechanical linkage slidably coupled between the housing and the lid, and configured to open and close the lid upon actuation of the motor unit.

17. The animal feeding system of claim 13, wherein the motor unit includes a motor shaft coupled to the lid, wherein the motor unit is fixably mounted to the housing, and wherein the motor unit is configured to rotatably open and close the lid upon actuation of the motor unit.

18. The animal feeding system of claim 13, wherein the control unit includes a memory unit configured to store instructions.

19. The animal feeding system of claim 18, wherein the control unit includes a processing unit configured to execute the instructions.

20. The animal feeding system of claim 19, wherein then control unit includes a program interface configured to receive the instructions from a communication link and to store the instructions in the memory to program the control unit.
